(19) United States
(12) Patent Application Publication
(10) Pub. No.: US 2013/0193245 A1
(43) Pub. Date: Aug. 1, 2013

(54) Apparatus and method for producing crumb rubber

(71) Applicant: David M. Futa, South Bend, IN (US)

(72) Inventor: David M. Futa, South Bend, IN (US)

(21) Appl. No.: 13/385,017

(22) Filed: Jan. 27, 2012

(51) Int. Cl. B02C 17/16

(52) U.S. Cl. 241/27

(57) ABSTRACT

The apparatus and method produces fine mesh crumb rubber and provides for independently driving two parallel rolls, with one roll turning at tip speeds far above conventional cracker mills. Turning the roll at a rate (rpms) that results in “hyper” outer roll surface speeds between 1000 ft/min and 1300 ft/min., which is four and a half times the normal maximum speed of conventional mills yields several unexpected and beneficial results. The previously expected effects of operating at surface speeds about 400 ft/min are reduced or eliminated.

This invention relates to an apparatus and method of producing fine mesh crumb rubber, and in particular a cracker mill having parallel rolls that turn at “hyper” tip speeds.

### BACKGROUND OF THE INVENTION

Scrap automotive and truck tires can be recycled into chipped tires (large wire-free shredded chunks) or crumb rubber (fine wire free granular particles). Scrap tires are generally processed into crumb rubber either by the use of cryogenic reduction processes or using mechanical grinders, called “cracker mills.” Cryogenic reduction is clean and fast, and produces a crumb rubber of a fine mesh size, but is more costly than mechanically grinding crumb rubber in cracker mills. Cracker mills are well established and can produce crumb rubber of varying particle sizes (grades) and quality at a relatively low cost.

Cryogenic reduction processes consist of freezing the shredded rubber at an extremely low temperature—far below the glass transition temperature of the rubber, then shattering the frozen rubber into small particles using a hammer or turbo mill. The cryogenic reduction process generally produces very fine rubber with a faceted or granular configuration.

Cracker mills mechanically grind shredded rubber material into finer grade crumb rubber by passing the material through a narrow gap between two parallel counter rotating rolls. The ground material may be passed repeatedly through a cracker mill in order to achieve the desired particle size. Cracker mills generally produce crumb rubber particles that have a rough surface texture that resembles “pop corn” or “cauliflower.” Consequently, crumb rubber of any particular grade or size produced from a cracker mill generally has a surface area as much as 13 times greater than the smooth faceted surface area of crumb rubber produced using cryogenic processes. The surface area of the crumb rubber particles is critical for strength in cross linking when used in recycled products.

The volume of particles produced during the mechanical grinding process is generally a function of several variables, particularly, tip speed, friction ratio and surface area of the rolls. The rolls of the cracker mill turn at different speeds that tear the bonds of the rubber while under compression in the tight gap between the rolls. The ratio of the different speeds of the rolls is referred to commonly as the “friction ratio” and can vary greatly. Generally, operating the mill at a greater friction ratio produces a greater material throughput, i.e. more particles are produced when passed between the rolls. Friction ratios commonly run between 2 to 1 and 20 to 1. “Tip speed” is the velocity of the outer surface of the faster turning roll. Increasing the tip speed generally increases the throughput. Similarly, increasing the length and diameter of the rolls generally allows more material to be ground with each pass.

The mechanical grinding of shredded tires and other rubber products into crumb rubber in a cracker mill generates considerable heat. Often the temperature of the crumb rubber coming out of a cracker mill reaches temperatures of the rubber, where the rubber begins to melt, defeating the grinding process. Heretofore, it was conventional wisdom that increasing the “tip” speed” while increasing throughput, also increased the temperature of the material being ground. Consequently, conventional wisdom in the industry believed that the “tip” speed of conventional cracker mills had a limit, which was generally around 375 ft/min. At tip speeds above 400 ft/min the input material begins to over heat and become sticky adhering to the rolls and adjacent rubber particles. Material temperatures often reach the rubber material's flash point and become fire hazards. In addition, at tip speeds about 400 ft/min, the process begins to generate smoke as volatile elements in the rubber are driven off.

### SUMMARY OF THE INVENTION

The present invention seeks to provide an improved apparatus and method for processing large particle crumb rubber into fine mesh crumb rubber. The cracker mills embodying this invention are similar in design and operation to conventional cracker mills, but are adapted to turn the “fast” roll at tip speeds far above conventional cracker mills. Operating in accordance with the method of this invention, the fast roll is turned at tip speeds between 1000-1300 ft/min., far above the maximum tip speed of conventional cracker mills. Driving the fast roll within this “hyper tip speed” range yields several unexpected and beneficial results. The previously expected effects of operating at surface speeds above 400 ft/min are eliminated. Driving the fast roll at tip speeds within the “hyper tip speed” range radically changes process dynamics of the cracker mill so that the rubber particles are processed by a “rapid compressive embrittlement fracture” where the rubber particles are compressed at compression ratios above the elastic limit of the feed material, but for such a short period of time that the thermal energy and mechanical stress of the compression cannot be propagated or dissipated within the molecular structure of the particles so that the particles deform and fracture adiabatically into smaller particles. The rubber particles lose their elasticity as the molecules do not have the required equilibrium time to reorient and the compression and shear forces fracture the particles in a phenomenon similar to shattering glass. Consequently, the yield of finer particles is greater than with conventional cracker mills.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an embodiment of a cracker mill using the method of this invention to process crumb rubber;

FIG. 2 is a top view of the cracker mill of FIG. 1 with portions cut away to show the rolls;

FIG. 3 is a simplified side sectional view of the cracker mill of FIG. 1;

FIG. 4 is a partial cross sectional view of the rolls showing the compression area of the mill; and

FIG. 6 is a line graph of the data from Table A identified as Graph A.

### DESCRIPTION OF THE PREFERRED EMBODIMENT

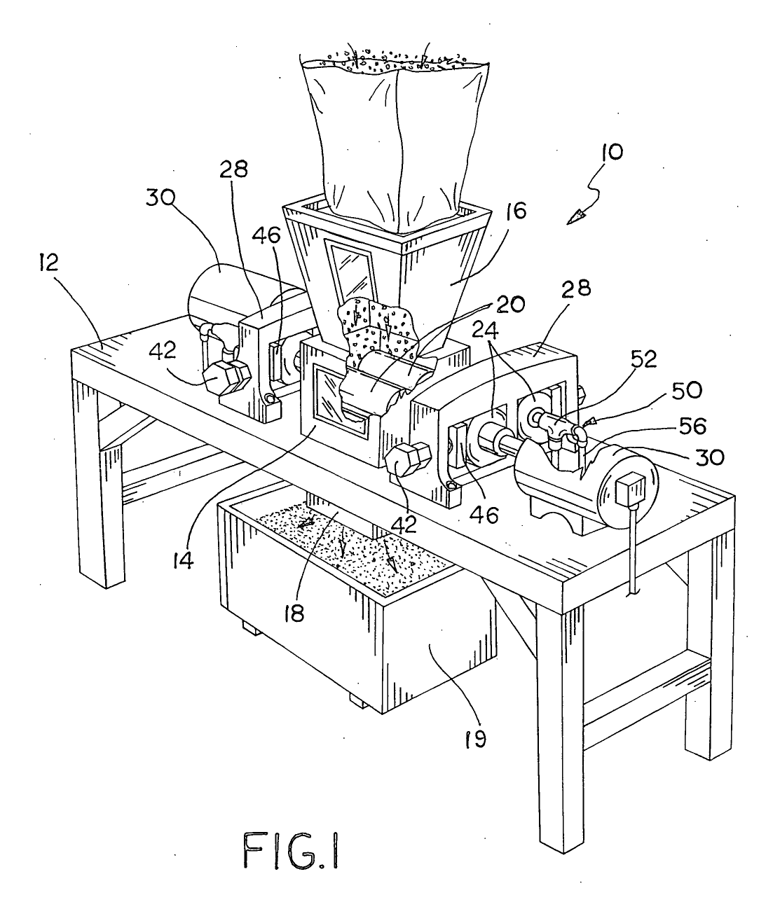

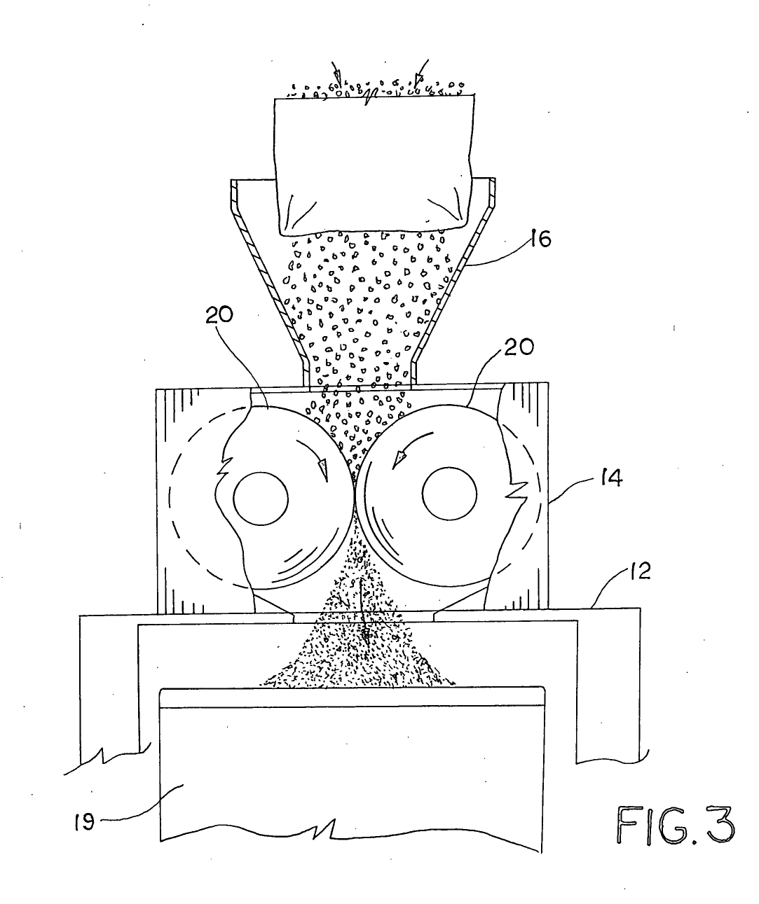

Referring now to the drawings, FIGS. 1-3 illustrate an embodiment of a cracker mill of this invention, which is designated generally as reference numeral 10. Cracker mill 10 is similar in design and operation to convention cracker mills, but is adapted so that one of the rolls, the fast roll, turns at tip speeds between 1000-1300 ft/min. to produce a fine mesh crumb rubber at a higher yield per pass using the processing method of this invention.

As shown, cracker mill 10 is built atop a base table 12, which supports the various mill components. Cracker mill 10 includes a pair of independently driven parallel rolls 20. Rolls 20 are typically made of a suitable hardened steel alloy, such as 8620, which has a high degree of stiffness to provide the rigidity to resist bending in a radial direction. Each roll 20 is approximately twelve inches in length and approximately six inches in diameter.

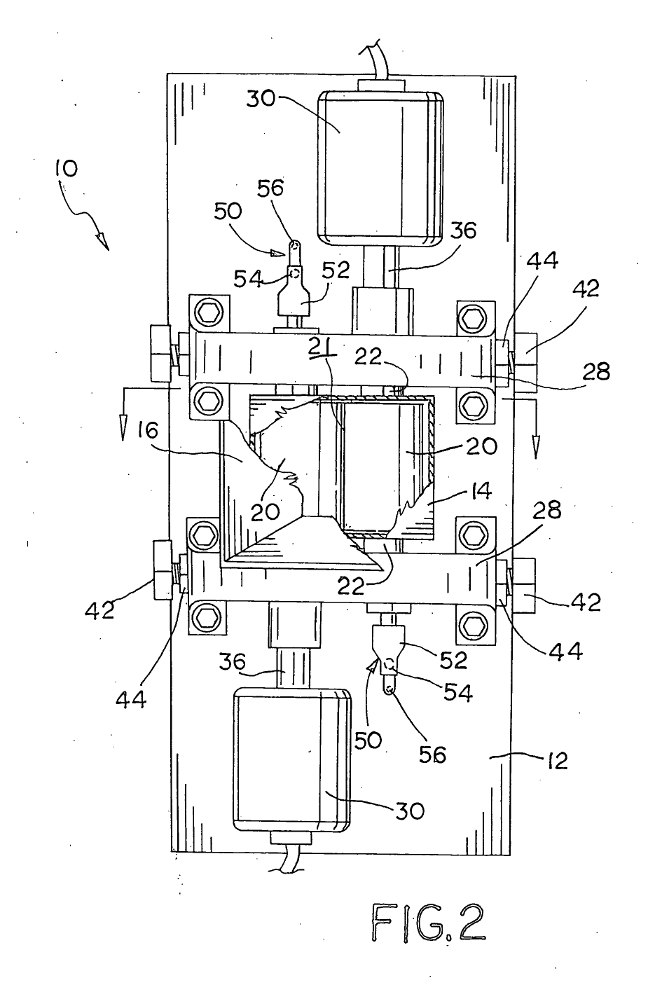

Rolls 20 are positioned closely adjacent one another (FIG. 2) to create between them a very small “roll gap” 21, through which material passes in the grinding process. During operation, one of rolls 20 rotates at a slower speed than the other roll to produce a shear force on the material passing between the rolls. Rubber particles are highly compressed between rolls 20 and are quickly sheared into small mesh sized particles as they pass through roll gap 21. The width of roll gap 21 is adjustable and is set so that input material particles are compressed, beyond the elastic limit of the material. Generally, roll gap 21 is set so that the input material is compressed at a ratio above the elastic limit of the feed material. By way of example only, roll gap 21 is approximately 76 microns (0.003 inches) in width for a typically input material with particles between 600-2000 microns (4-10 mesh crumb rubber).

Rolls 20 are journaled between self-aligning bearings 24 shiftably supported between a pair of opposed bearing pedestals 28 mounted atop base table 12. Each roll 20 has an axial drive shaft 22 whose ends are journaled in bearings 24. Each roll 20 is driven by its own independent motor 30. Both motors 30 are controlled by a conventional electronic controller (not shown).

A roll gap adjustment mechanism allows the rolls to be aligned parallel and the width of the gap between the rolls to be adjusted. The width of roll gap 21 may be adjusted to ensure that rolls are parallel to each other and to slightly vary the width of the roll gap, generally between 0.002 inches and 0.005 inches (50-125 microns). The roll gap adjustment mechanism includes a pair of adjustment screws 42 received within threaded bores in the ends of each bearing pedestal 14, a pair of lock nuts 44 and two pusher plates 46 located within the open interior 15 of the bearing pedestal. Pusher plates 46 abut self-aligning bearings 24 of rolls 20 so that turning adjustment screw 42 moves the bearings and its roll toward and away from the bearing of the other roll.

Cracker mill 10 also includes a roll coolant system 50, which circulates coolant through both rolls 20. The circulated coolant may be water or other suitable cooling medium. Coolant system 50 includes a chilling unit (not shown), a roll shaft coolant coupling 52 and feed and return lines 54 and 56. Coolant coupling 52 is connected to the end of roll shaft 22 opposite motor 30 and communicates coolant from the chiller unit into rolls 20. Feed lines 54 and return lines 56 connect shaft couplings 52 to the chiller unit. Each roll has a central passage (not shown) and radial outer passages (not shown) through which the coolant circulates through the rolls.

Cracker mill 10 includes a roll housing 14, feed chute 16 located above the roller housing and an output chute 18 located beneath the roll housing. Typically a conveyer or auger deposits feed material, typically chipped rubber or larger particle crumb rubber to be further ground, into the feed chute, which is metered into roll housing 14. Feed chute 16 extends approximately one eighth of an inch from rolls 20 to ensure material falls directly onto the rolls and into roll gap 21. Crumb rubber falling through output chute 18 collects in a bin 19 and can be transported away on a conveyer or auger (also not shown).

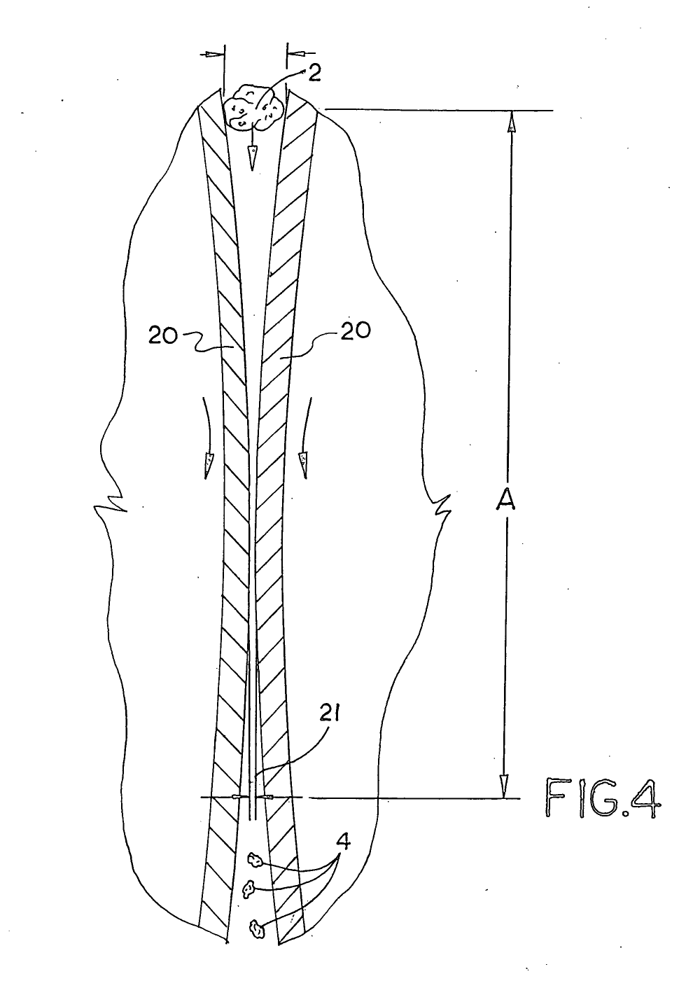

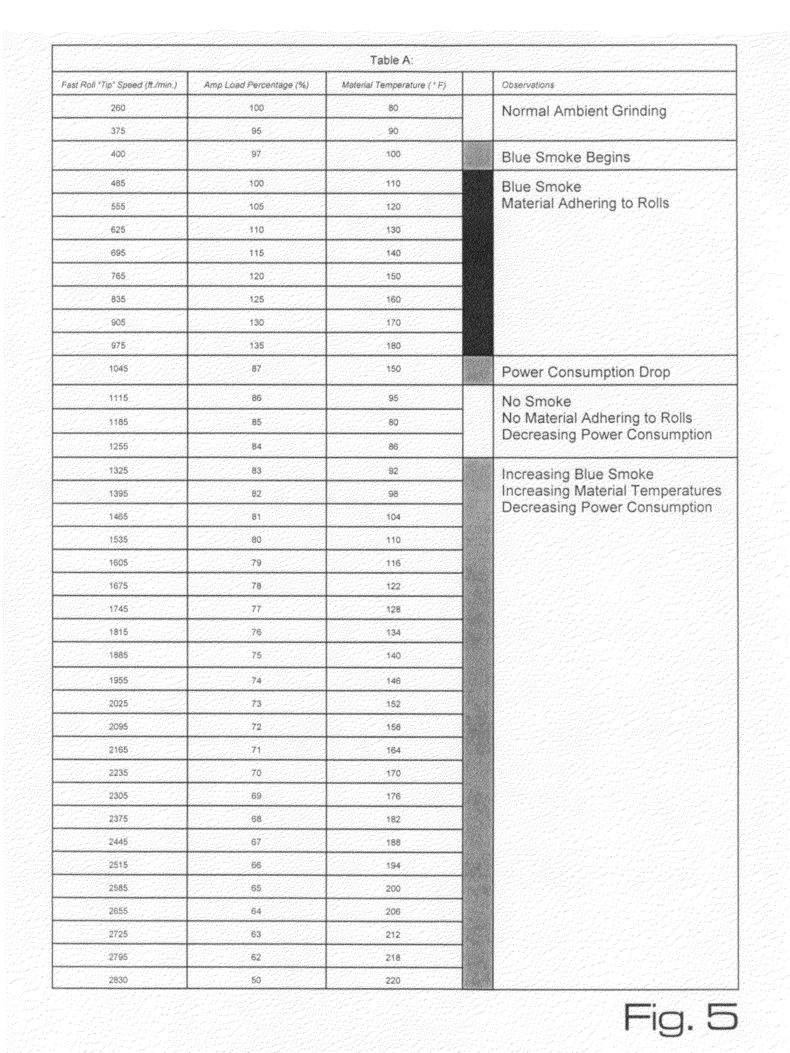

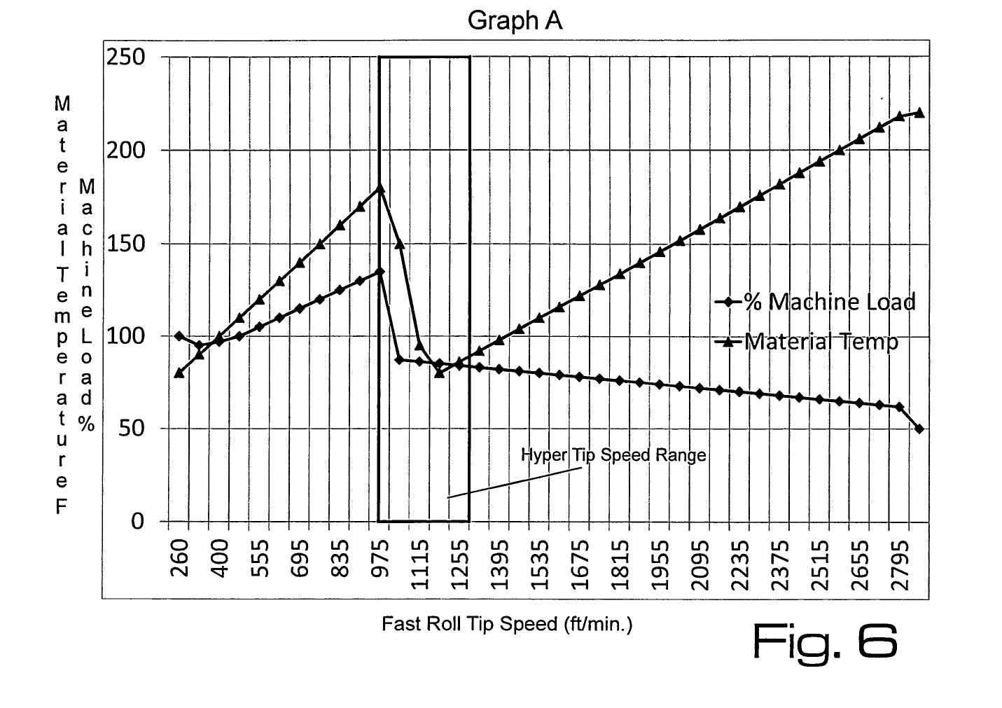

FIG. 4 is a cross sectional view of rolls 20, which illustrates the compression area A where the feed particles 2 are compressed and fractured as they pass between the rolls. Once a feed particle 2 is compressed beyond its elastic limit (approximately four to one for rubber), the particle fractures into smaller particles 4 and will fall further down into the nip until small enough to squeeze through gap 21 at a compression ratio less than its elastic limit. The compression area is defined by the geometry of the rolls 20 and roll gap 21 in relation to the size of the material particles being feed into cracker mill 10. By way of example only, a 4 Mesh (4760 micron) feed particle will have a longer compression area and experience a much greater compression ratios than an 18 Mesh (1000 micron) feed particle. Regardless of the size, feed particles passing between rolls 20 with a roll gap 21 of 0.005 inches generally produce 35 Mesh (500 micron) crumb rubber.

### Operation and Method

Cracker mill 10 operating in accordance with the method of this invention turns one roll (the “fast” roll) at tip speeds between 1000-1300 ft/min., which is far beyond the conventional maximum tip speed of 400 ft/min. Operating cracker mill 10 with fast roll tip speeds within this “hyper tip speed” range yields several unexpected and beneficial results. The previously expected effects of operating at tip speeds above 400 ft/min, namely the release of volatile-filled smoke and the adherence of material to the rolls, are reduced and eliminated when the fast roll turns at tips speeds within this “hyper tip speed” range.

Data Table A below and Graph A of FIG. 5 show material temperature and motor load data for cracker mill 10 operating at friction ratio of 12 to 1 and a consistent material feed rate with the fast roll turning at various tip speeds. With respect to Table A and Graph A, the amperage load percentage is the percentage of the maximum load rating for the given electrical motor driving the fast roll. In addition, the material temperature of Table A and Graph A is the temperature of the material exiting the cracker mill.

TABLE A

| Fast Roll “Tip” | Amp Load | Material | |
|---|---|---|---|
| Speed | Percentage | Temperature | |
| (ft./min.) | (%) | (° F.) | Observations |
| 260 | 100 | 80 | Normal Ambient Grinding |
| 375 | 95 | 90 | |
| 400 | 97 | 100 | Blue Smoke Begins |
| 485 | 100 | 110 | Blue Smoke |
| 555 | 105 | 120 | Material Adhering to Rolls |
| 625 | 110 | 130 | |
| 695 | 115 | 140 | |
| 765 | 120 | 150 | |
| 835 | 125 | 160 | |
| 905 | 130 | 170 | |
| 975 | 135 | 180 | |
| 1045 | 87 | 150 | Power Consumption Drop |
| 1115 | 86 | 95 | No Smoke or Material |
| 1185 | 85 | 80 | Adhering to Rolls, Power |
| 1255 | 84 | 86 | Consumption Decrease |
| 1325 | 83 | 92 | Increasing Blue Smoke, |
| 1395 | 82 | 98 | Increasing Material |
| 1465 | 81 | 104 | Temperatures, Decreasing |
| 1535 | 80 | 110 | Power Consumption |
| 1605 | 79 | 116 | |
| 1675 | 78 | 122 | |
| 1745 | 77 | 128 | |
| 1815 | 76 | 134 | |
| 1885 | 75 | 140 | |
| 1955 | 74 | 146 | |
| 2025 | 73 | 152 | |
| 2305 | 69 | 176 | Increasing Blue Smoke |
| 2375 | 68 | 182 | Increasing Material |
| 2445 | 67 | 188 | Temperatures |
| 2515 | 66 | 194 | Decreasing Power |
| 2585 | 65 | 200 | Consumption |
| 2655 | 64 | 206 | |
| 2725 | 63 | 212 | |
| 2795 | 62 | 218 | |
| 2830 | 50 | 220 | |

As evidenced by Table A and Graph A, driving the fast roll at tip speeds within the “hyper tip speed” range of 1000-1300 ft/min. radically changes process dynamics of cracker mill 10. As shown, when the fast roll tip speeds exceeds 1000 ft/min., the temperature of the material and the energy consumption of the mill drops dramatically. Above a fast roll tip speed of 1000 ft/min., the rubber particles are processed by a “compressive embrittlement fracture” where the rubber particles pass through compression area A between rolls 20 and are compressed at compression ratios far exceeding their elastic limits (normally a compression ration of four to one), but for such a short period of time that the thermal energy and mechanical stress of the compression cannot be propagated or dissipated within the molecular structure of the particles so that the particles deform and fracture adiabatically into smaller particles. Passing the rubber particles through compression area A between roll gap 21 generates a compressive force on the particles that far exceeds the elastic limit of the material, typically experiencing compression ratios greater than 10 to 1; however, because the fast roll turns at tip speeds above 1000 ft/min., the rubber particles pass through compression area A in less than a 1.6 millisecond, typically between 0.001 and 0.0005 seconds, ensuring that the particles only experience the extreme compressive force for a fraction of an instant. Under these conditions, the rubber particles lose their elasticity and the compression and shear forces fracture the particles in a phenomenon similar to shattering glass.

As shown in Table A and Graph A, there is a significant drop in material temperature once the fast roll tip speeds reaches 1000 ft/min. The drop in material temperature can be attributed to the “compressive embrittlement fracture” of the particles, that is the rubber particles fracture before thermal energy normally associated with the process can be generated within the molecular structure of the particles. In addition, there is an increase in mechanical efficiency of cracker mill 10 in terms of throughput and power consumption. At tip speeds above 1000 ft/min., the cracker mill requires less amperage to drive the fast roll. As shown, the amperage load on the motor driving the fast roll drops significantly at a tip speed around 1000 ft/min and steadily decreased thereafter. While the power consumption of the cracker mill decreases steadily with fast roll tip speeds above 1000 ft/min., material temperatures also increase linearly. At fast roll tip speeds above 1300 ft/min., the material temperature begins to match the maximum material temperature at conventional tip speeds, thereby yielding an upper limit for the hyper tip speed range.

It should be noted that the apparatus and method of this invention could be adapted for use in processing other materials into fine mesh particles, such as plastics and other polymers. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A method for processing material particles into smaller material particles, the method comprising:
rotating a pair of rigid rolls disposed closely adjacent one another with a preset gap therebetween so that one of the pair of rolls turns at a tip speed between 1000 feet per minute and 1300 feet per minute; and
feeding the material particles between the pair of rolls whereby the material particles are fractured into the smaller particles.

2. The method of claim 1 wherein the preset gap between the pair of rolls exceeds the elastic limit of the material particles.

3. The method of claim 1 wherein feeding the material further includes displacing the material between the pair of rolls to compress and shear the material into particles.

4. The method of claim 1 wherein feeding the material particles between the pair of rolls compresses the material particles at a compression ratio above the elastic 1.6 limit of the material particles for a less than a 0.001 of a second.

5. The method of claim 1 wherein the other of the pair of rolls turns at a tip speed less than the one of the pair of rolls thereby creating a shear force on the material particles when feed between the pair of rolls.

6. The method of claim 1 wherein the compression ratio is above ten to one.

7. A method for processing material particles into smaller material particles comprising:
compressing the material particles at a compression ratio greater than the elastic limit of the material particles for less than 0.001 of a second, whereby the material particles fracture into the smaller material particles.

8. The method of claim 7 wherein compressing the material particles includes passing the material particles between a pair of rigid rotating rolls disposed closely adjacent one another with a preset gap therebetween.

9. The method of claim 8 wherein one of the pair of rolls turns at a tip speed between 1000 feet per minute and 1300 feet per minute

10. The method of claim 7 wherein the compression ratio is above ten to one.
